(19) United States
(12) Patent Application Publication
(10) Pub. No.: US 2026/0370109 A1
(43) Pub. Date: Nov. 19, 2026

(54) DUAL STATOR MOTOR AND VEHICLE DRIVE SYSTEM USING THE SAME

(71) Applicants: Hyundai Motor Company, Seoul (KR); Kia Corporation, Seoul (KR)

(72) Inventor: Woong Chan Chae, Hwaseong-si (KR)

(21) Appl. No.: 19/399,478

(22) Filed: Nov. 24, 2025

(30) Foreign Application Priority Data
May 14, 2025 (KR) 10-2025-0062283

(51) Int. Cl. H02K 16/04; B60L 53/22; H02K 1/14; H02K 1/16; H02K 7/00; H02K 7/108

(52) U.S. Cl. CPC H02K 16/04; B60L 53/22; H02K 1/146; H02K 1/165; H02K 7/006; H02K 7/108

(57) ABSTRACT

Disclosed is a dual stator motor that includes a first stator and a second stator. The first stator includes a first stator core and first coils wound around the first stator core. The first stator core includes first teeth arranged in a circumferential direction. Each of the first coils is wound around each of the plurality of first teeth. The second stator includes a second stator core and second coils wound around the second stator core. The second stator core includes second teeth arranged in a circumferential direction. Each of the second coils is wound around two or more of the plurality of second teeth. A rotor is disposed between the first stator and the second stator and concentric with the first stator and the second stator

### CROSS-REFERENCE TO RELATED APPLICATIONS

This application claims, under 35 U.S.C. § 119(a), the benefit of and priority to Korean Patent Application No. 10-2025-0062283, filed on May 14, 2025, the entire contents of which are incorporated herein by reference.

### TECHNICAL FIELD

The present disclosure relates to a dual stator motor that has two stators and a vehicle drive system using the dual stator motor.

### BACKGROUND

Among vehicles that use electric motors as a driving source for travel, an extended range electric vehicle (EREV) charges a battery using a power generation-only engine and a power generation motor.

Most EREVs of related arts use an all-wheel drive (AWD) system, and in addition to the power generation motor, a drive motor that acts as a driving source for travel is mounted on each of a front-wheel drive shaft and a rear-wheel drive shaft.

Accordingly, the EREVs of related arts use a three-motor system including a power generation motor and two drive motors, which causes the structure to be complicated and increases manufacturing costs.

To solve the problems of the EREVs of related arts, a two-motor system in which the power generation motor is removed and a disconnector is mounted on the front-wheel drive shaft is being studied.

In the two-motor system, two drive motors are mounted on the front-wheel drive shaft and the rear-wheel drive shaft, respectively. One of the motors (i.e., a first motor) is connected to the power generation-only engine to perform the function of the power generation motor.

The first motor serves as the power generation motor when connected to the power generation-only engine, and when needed, the first motor serves as the drive motor by being disconnected from the power generation-only engine. For example, the first motor serves as the drive motor when the vehicle travels in four-wheel drive.

When the first motor serves as the drive motor, high output is required so as to assist the vehicle's starting performance, and when the first motor serves as the power generation motor, high efficiency corresponding to the optimal operating line (OOL) area of the power generation-only engine is required.

When the first motor operates in response to a high output demand, iron loss mainly occurs, and when the first motor operates in response to a high efficiency demand, copper loss mainly occurs.

Because the main loss factor differs depending on the role required of the first motor, there is a limit to the optimization of the two-motor system using the first motor.

The above information disclosed in this Background section is only for enhancement of understanding of the background of the present disclosure, and therefore it may contain information that does not form the related art that is already known to a person of ordinary skill in the art.

### SUMMARY

Embodiments described in the present disclosure can solve problems associated with the related art. Various embodiments of the present disclosure provide a dual stator motor and a vehicle drive system using the same, wherein the dual stator motor has two stators with different winding methods, reducing motor losses that vary with operation modes.

Embodiments of the present disclosure are not limited to the foregoing, and other embodiments not mentioned herein will be clearly understood by those of ordinary skill in the art to which the present disclosure pertains based on the description below.

The present disclosure provides a dual stator motor including a first stator including a first stator core and a plurality of first coils wound around the first stator core, a second stator including a second stator core and a plurality of second coils wound around the second stator core, and a rotor disposed between the first stator and the second stator and concentric with the first stator and the second stator. Here, the first stator core may include a plurality of first teeth arranged in a circumferential direction, wherein each of the plurality of first coils is wound around each of the plurality of first teeth, and the second stator core may include a plurality of second teeth arranged in a circumferential direction, wherein each of the plurality of second coils is wound around two or more of the plurality of second teeth.

According to an embodiment of the present disclosure, the first stator may be arranged radially outside the rotor, and the second stator may be positioned radially inside the rotor.

According to another embodiment of the present disclosure, the second stator may be arranged radially outside the rotor, and the first stator may be positioned radially inside the rotor.

Moreover, the present disclosure provides a vehicle drive system including a first motor mounted on a first drive shaft, a second motor mounted on a second drive shaft, a battery configured to provide a current to the first motor and the second motor, and a power generation-only engine connected to the first motor via a clutch. The first motor includes a first stator including a first stator core and a plurality of first coils wound around the first stator core, a second stator including a second stator core and a plurality of second coils wound around the second stator core, and a rotor disposed between the first stator and the second stator and concentric with the first stator and the second stator. Here, the first stator core may include a plurality of first teeth arranged in a circumferential direction, wherein each of the plurality of first coils may be wound around each of the plurality of first teeth, and the second stator core may include a plurality of second teeth arranged in a circumferential direction, wherein each of the plurality of second coils may be wound around two or more of the plurality of second teeth.

According to an embodiment of the present disclosure, based on the power generation-only engine operating, the plurality of first coils and the plurality of second coils may not be supplied with a current, and the clutch may be operated in a connection mode to connect the power generation-only engine to the first motor.

Moreover, according to an embodiment of the present disclosure, based on the power generation-only engine not operating, in response to a required acceleration of the vehicle being smaller than a predetermined acceleration, a current may be applied to the plurality of second coils but not to the plurality of first coils, and the clutch may be operated in a disconnection mode to disconnect the power generation-only engine from the first motor.

Furthermore, according to an embodiment of the present disclosure, based on the power generation-only engine not operating, in response to a required acceleration of the vehicle being greater than or equal to a predetermined acceleration, a current may be applied to both the plurality of first coils and the plurality of second coils.

Other embodiments of the present disclosure are discussed herein.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed herein.

### BRIEF DESCRIPTION OF THE DRAWINGS

The above and other features of the present disclosure will now be described in detail with reference to various embodiments thereof illustrated in the accompanying drawings which are given herein below by way of illustration only, and thus are not limitative of the present disclosure, and wherein:

FIG. 1 is a perspective view illustrating a dual stator motor according to an embodiment of the present disclosure;

FIG. 2 is a plan view illustrating a dual stator motor according to an embodiment of the present disclosure;

FIG. 3 is an exploded perspective view illustrating a dual stator motor according to an embodiment of the present disclosure;

FIG. 4 is a perspective view partially illustrating a second motor of a dual stator motor according to an embodiment of the present disclosure;

FIG. 5 is a plan view illustrating a dual stator motor according to another embodiment of the present disclosure;

FIG. 6 is a perspective view illustrating a dual stator motor according to still another embodiment of the present disclosure;

FIG. 7 is a configuration diagram illustrating a vehicle drive system using a dual stator motor according to an embodiment of the present disclosure; and

FIG. 8 is a flowchart showing a method for controlling a vehicle drive system according to an embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent parts of the present disclosure throughout the several figures of the drawing.

### DETAILED DESCRIPTION OF ILLUSTRATIVE EMBODIMENTS

Hereinafter, embodiments of the present disclosure will be described with reference to the accompanying drawings. The matters described in the attached drawings may be different from those actually implemented in order to facilitate description of the embodiments of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of various embodiments of the present disclosure.

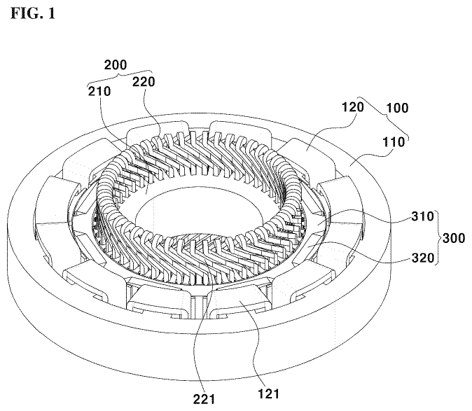

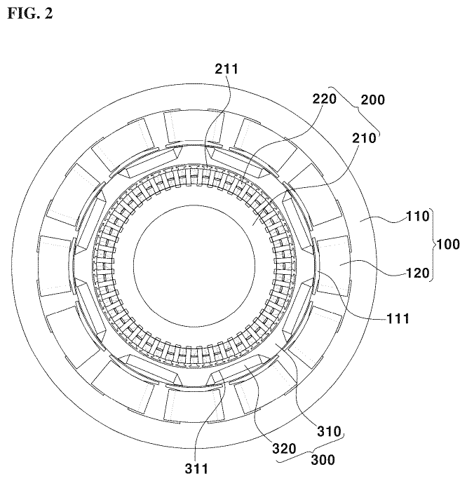

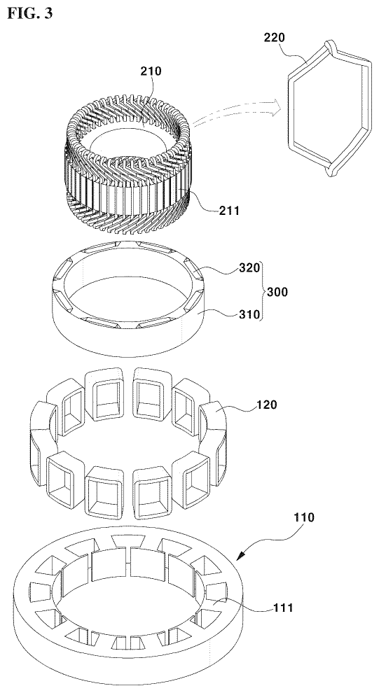

As illustrated in FIGS. 1 to 3, a dual stator motor according to an embodiment of the present disclosure includes a first stator 100, a second stator 200, and a rotor 300.

The first stator 100 includes a first stator core 110 and a plurality of first coils 120 wound around the first stator core 110 in a tooth-concentrated winding manner. The first stator 100 is arranged radially outside the rotor 300 and is concentric with the rotor 300.

The first stator core 110 is a cylindrical structure and has an inner wall from which a plurality of first teeth 111 protrudes. The plurality of first teeth 111 is arranged in a circumferential direction and spaced apart at predetermined intervals.

The plurality of first coils 120 is wound one-to-one around the plurality of first teeth 111. In other words, each of the plurality of first coils 120 is wound around each of the plurality of first teeth 111. That is, one first coil 120 is wound around one first tooth 111.

The second stator 200 includes a second stator core 210 and a plurality of second coils 220 wound around the second stator core 210 in a distributed winding manner. The second stator 200 is arranged radially inside the rotor 300 and is concentric with the rotor 300 and the first stator 100.

The second stator core 210 is a cylindrical structure having a smaller radius than the first stator core 110, and has an outer wall from which a plurality of second teeth 211 protrudes. The plurality of second teeth 211 is arranged in a circumferential direction and spaced apart at predetermined intervals. The gaps between the plurality of second teeth 211 are smaller than the gaps between the plurality of first teeth 111.

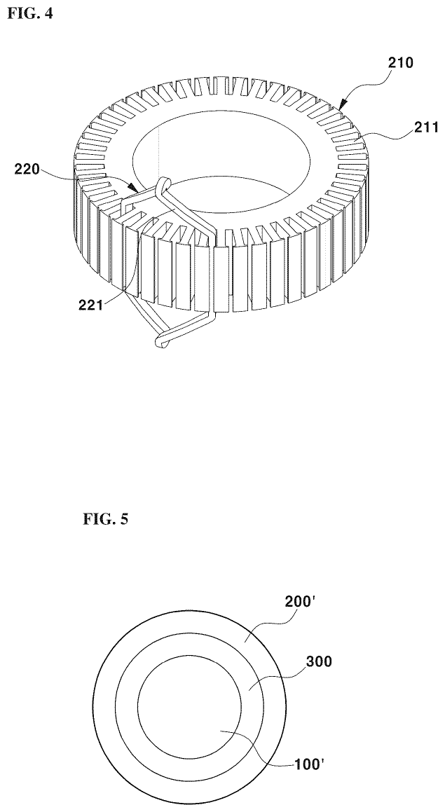

The plurality of second coils 220 is wound one-to-many around the plurality of second teeth 211. In other words, referring to FIG. 4, one second coil 220 is wound around two or more second teeth 211.

The rotor 300 is disposed between the first stator 100 and the second stator 200, and is concentric with the first stator 100 and the second stator 200. In other words, the rotor 300 is arranged radially inside the first stator 100 and is arranged radially outside the second stator 200.

The rotor 300 may be a general motor rotor. For example, the rotor 300 may be a rotor used in a surface-mounted permanent magnet motor (SPM), an interior permanent magnet motor (IPM), and a wound rotor synchronous motor (WRSM).

Referring to FIG. 1, the rotor 300 may include a rotor core 310 and a plurality of permanent magnets 320 mounted inside the rotor core 310. Here, the rotor core 310 has a plurality of insertion holes 311 into which the permanent magnets 320 are inserted. Moreover, although not illustrated in the drawing, a rotation shaft (not shown) is assembled at the central portion of the rotor core 310.

The rotor core 310 may have a length same as those of the first stator core 110 and the second stator core 210 in an axial direction. In other words, the axial length of the rotor core 310 may be the same as the axial length of the first stator core 110 and the axial length of the second stator core 210.

Meanwhile, a dual stator motor according to another embodiment of the present disclosure may have a structure in which a second stator 200′ is arranged radially outside a rotor 300 and a first stator 100′ is arranged radially inside the rotor 300.

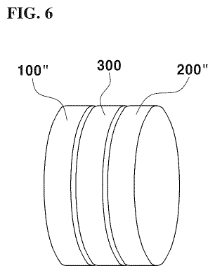

In other words, referring to the embodiment illustrated in FIG. 5, the dual stator motor of the present disclosure may have a structure in which the second stator 200′ with a distributed winding pattern is arranged radially outside the first stator 100′ with a tooth-concentrated winding pattern. Here, the first stator 100′ is provided with a first coil on an outer wall of the first stator 100′ facing the rotor 300, and the second stator 200′ is provided with a second coil on an inner wall of the second stator 200′ facing the rotor 300.

Moreover, referring to still another embodiment illustrated in FIG. 6, a first stator 100″ with a tooth-concentrated winding pattern and a second stator 200″ with a distributed winding pattern may be arranged in a line with a rotor 300″ in an axial direction. Here, the first stator 100″ and the second stator 200″ each may be provided with a coil on a wall facing the rotor 300.″

The dual stator motor of the present disclosure includes the first stator 100 in which the first coil 120 is wound in the tooth-concentrated winding manner, and the second stator 200 in which the second coil 220 is wound in the distributed winding manner.

Generally, the coil of an electric motor generates a magnetic force when a current is applied, but the end coil portion generates almost no magnetic flux and only generates Joule loss, causing large copper loss. The end coil portion is an end portion of the coil that protrudes axially outward from the core.

The first stator 100 that applies the tooth-concentrated winding manner has a relatively small coil pitch between the first coils 120 and has a small end coil portion (i.e., first end coil portion). Accordingly, the first stator 100 has excellent packaging properties and is advantageous in terms of resistance (i.e., copper loss).

The second stator 200 that applies the distributed winding manner has relatively excellent harmonic characteristics and is advantageous in iron loss because the magnetic force of one phase is distributed to multiple slots. The slots are gaps between the second teeth 211.

On the other hand, the second stator 200 incurs greater copper loss because the end coil portion (i.e., second end coil portion) of the second coil 220 is relatively long, and the first stator 100 incurs greater iron loss because relatively a large amount of harmonics is generated.

Moreover, the second stator 200 may increase the amount of torque generation by utilizing the reluctance torque, and is advantageous for high torque output.

Because the axial length of the second end coil portion 221 is greater than the axial length of the first end coil portion 121, a dead space is generated at the radially outer or inner side of the second end coil portion 221. Accordingly, the axial length of the first stator core 110 may be extended longer than the axial length of the second stator core 210. The first stator core 110 may be extended by the length of the second end coil portion 221.

The dual stator motor of the present disclosure satisfies the design specifications of a general electric motor. In other words, the dual stator motor of the present disclosure satisfies Equation 1 below.

S/P=Np×n Equation 1

wherein S denotes the number of teeth of the first stator 100 or the number of teeth of the second stator 200, P denotes the number of poles of the rotor 300, Np denotes the number of phases of the first stator 100 or the number of phases of the second stator 200, and n denotes a natural number.

The dual stator motor of the present disclosure may be, when used in a drive system of an extended range electric vehicle (EREV), controlled in a first operation mode to serve as a power generation motor and may be controlled in a second operation mode to generate a driving force.

The first operation mode is a mode to allow the dual stator motor to serve as a power generation motor to charge a battery, and the second operation mode is a mode to allow the dual stator motor to serve as a drive motor to generate a driving force for vehicle travel.

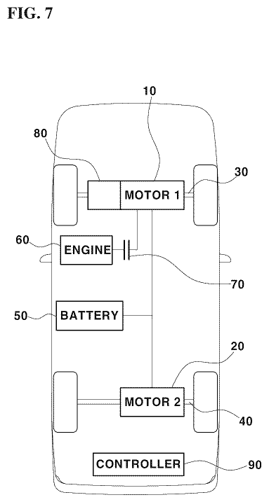

FIG. 7 is a configuration diagram illustrating a vehicle drive system using the dual stator motor of the present disclosure.

As illustrated in FIG. 7, the vehicle drive system using the dual stator motor of the present disclosure includes a first motor 10, a second motor 20, and a power generation-only engine 60.

The first motor 10 is mounted on a first drive shaft 30 which is one of the front-wheel drive shaft and the rear-wheel drive shaft of the vehicle. The second motor 20 is mounted on a second drive shaft 40 which is the other one of the front-wheel drive shaft and the rear-wheel drive shaft.

A disconnector 80 configured to control the connection between the first drive shaft 30 and the first motor 10 is mounted on the first drive shaft 30. The disconnector 80 mechanically disconnects or connects the first drive shaft 30 and the first motor 10 from or to each other.

The first motor 10 serves as the dual stator motor of the present disclosure and is power-transmitably connected to the power generation-only engine 60 via a clutch 70. The power generation-only engine 60 is driven only for the purpose of charging a battery 50. The power generation-only engine 60 does not generate a driving force for vehicle travel.

The first motor 10 and the second motor 20 are electrically connected to the battery 50 mounted in the vehicle. The battery 50 is discharged so as to provide a driving current to the first motor 10 and to the second motor 20, or is charged by the first motor 10.

When the state of charge (SOC) of the battery 50 is relatively low, i.e., when the battery 50 needs to be charged, the power generation-only engine 60 is driven. To charge the battery 50, the first motor 10 is driven in the first operation mode to receive the mechanical energy generated by the power generation-only engine 60 and convert the energy into electrical energy. The electrical energy generated by the first motor 10 is charged in the battery 50.

Moreover, the first motor 10 operates in the second operation mode to generate a driving force for vehicle travel by using the electrical energy of the battery 50 under conditions where a large driving force is needed, such as when the vehicle is starting. The driving force for travel generated by the first motor 10 is provided to the first drive shaft 30.

When the first motor 10 operates in the first operation mode, the power generation-only engine 60 is controlled to follow a predetermined optimal operating line (OOL). Here, the power generation-only engine 60 generates relatively low-speed and high-torque output.

When the SOC of the battery 50 is relatively high and the battery 50 does not need to be charged, the first motor 10 is driven in the second operation mode to generate a driving force for travel. Here, the first motor 10 may be driven in boost mode or non-boost mode depending on the required torque of the vehicle.

When the first motor 10 is driven in the second operation mode, a current is basically applied to the second coil 220, and when a relatively high torque is needed, a current is applied also to the first coil 120.

For example, based on a required acceleration of the vehicle being less than a predetermined threshold acceleration A, a current is applied only to the second coil 220 but not to the first coil 120.

Based on the required acceleration of the vehicle being greater than or equal to the predetermined threshold acceleration A, the first motor 10 is demanded to generate high torque corresponding to the required acceleration. Here, the first motor 10 is driven in boost mode, and a driving current is applied to the first coil 120 along with the second coil 220 of the first motor 10. In other words, in order to generate high torque of the first motor 10, a driving current is applied to both the second coil 220 and the first coil 120. The currents applied to the first coil 120 and the second coil 220 are individually controlled.

To control the currents applied to the first motor 10 and to the second motor 20, an inverter (not shown) may be mounted between the first motor 10 and the battery 50 and between the second motor 20 and the battery 50. The inverter may control the current applied from the battery 50 to the first coil 120 and the second coil 220, and may also control the current charged in the battery 50 via the first motor 10 when the power generation-only engine 60 is driven. The inverter may be controlled by a controller 90 provided in the vehicle. The controller 90 may be a controller to perform overall control of the vehicle drive system.

As such, the operation mode of the first motor 10 may be determined according to the performance required for the first motor 10, optimizing the operation of the first motor 10.

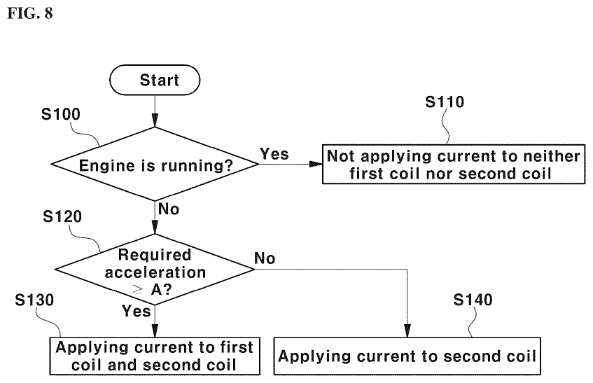

Here, the method for controlling the first motor 10 is explained as follows with reference to FIG. 8.

First, the controller 90 determines whether the power generation-only engine 60 is running, at operation S100. Based on determining that the power generation-only engine 60 is running, the controller 90 determines that the battery 50 needs to be charged, and does not apply a current to neither the first coil 120 nor the second coil 220 of the first motor 10, at operation s110.

Here, the disconnector 80 is operated in a disconnection mode to disconnect the first drive shaft 30 from the first motor 10, and the clutch 70 is operated in a connection mode to connect the power generation-only engine 60 to the first motor 10.

When the power generation-only engine 60 is not running, the controller 90 determines that the battery 50 does not need to be charged, and compares the required acceleration of the vehicle with the predetermined threshold acceleration A, at operation S120. As a result of the comparison, in response to the required acceleration of the vehicle being greater than or equal to the predetermined threshold acceleration A, a current is applied to both the first coil 120 and the second coil 220, at operation S130, and in response to the required acceleration being smaller than the predetermined threshold acceleration A, a current is applied only to the second coil 220 but not to the first coil 120, at operation S140.

In the case where a current is applied to both the first coil 120 and the second coil 220, the disconnector 80 operates in the connection mode to connect the first drive shaft 30 to the first motor 10, and the clutch 70 operates in the disconnection mode to disconnect the power generation-only engine 60 from the first motor 10. Moreover, even in the case, among the first coil 120 and the second coil 220, a current is applied only to the second coil 220, the disconnector 80 operates in the connection mode and the clutch 70 operates in the disconnection mode.

As is apparent from the above description, the present disclosure provides the following effects.

According to the summary above, the dual stator motor of the present disclosure has two stators with different winding methods, so that the two stators may be selectively driven depending on the performance and characteristics required of the motor, thus effectively reducing main losses that vary with the operation modes of the motor.

Specifically, according to the present disclosure, iron loss that occurs when the dual stator motor operates in a mode to generate a driving force for travel, and copper loss that occurs when the dual stator motor operates in a mode to charge a battery may be effectively reduced.

Effects of the present disclosure are not limited to what has been described above, and other effects not mentioned herein will be clearly recognized by those skilled in the art based on the above description.

Terms or words used in this specification and claims described below should not be construed as being limited to conventional or dictionary meanings. In addition, the scope of the present disclosure is not limited to the above-described embodiments, and various modifications and improvements by those skilled in the art using the basic concept of the present disclosure as defined in the claims below will also be included in the scope of the present disclosure.

What is claimed is:

1. A dual stator motor comprising:
a first stator comprising a first stator core and a plurality of first coils wound around the first stator core, wherein the first stator core comprises a plurality of first teeth arranged in a circumferential direction, wherein each of the plurality of first coils is wound around each of the plurality of first teeth;
a second stator comprising a second stator core and a plurality of second coils wound around the second stator core, wherein the second stator core comprises a plurality of second teeth arranged in a circumferential direction, wherein each of the plurality of second coils is wound around two or more of the plurality of second teeth; and
a rotor disposed between the first stator and the second stator and concentric with the first stator and the second stator.

2. The dual stator motor of claim 1, wherein the first stator is arranged radially outside the rotor, and the second stator is positioned radially inside the rotor.

3. The dual stator motor of claim 1, wherein the second stator is arranged radially outside the rotor, and the first stator is positioned radially inside the rotor.

4. The dual-stator motor of claim 1, wherein the first stator, the second stator, and the rotor have substantially identical outer radii and are coaxially arranged about a common cylindrical axis, the rotor being axially disposed between the first and second stators.

5. The dual stator motor of claim 1, wherein each of the plurality of first teeth comprises a first end coil portion that protrudes outward along an axial direction, and each of the plurality of second teeth comprises a second end coil portion that protrudes outward along the axial direction, wherein the second end coil portion protrudes farther along the axial direction than the first end coil portion.

6. The dual stator motor of claim 5, wherein an axial length of the first stator core is greater than an axial length of the second stator core, the first stator core being axially extended by an amount substantially equal to an axial length of the second end coil portion.

7. The dual stator motor of claim 1, wherein a ratio between a number of teeth of the first stator and a number of teeth of the second stator is greater than or equal to a number of phases of the first stator or a number of phases of the second stator.

8. The dual stator motor of claim 1, wherein the second stator core is disposed radially inward of the plurality of second teeth.

9. The dual stator motor of claim 1, wherein the first stator core is disposed radially outward of the plurality of first teeth.

10. The dual stator motor of claim 1, wherein a coil pitch between the first coils of the first stator is smaller than the coil pitch between the second coils of the second stator.

11. A vehicle drive system comprising:
a first drive shaft;
a second drive shaft;
a first motor mounted on the first drive shaft;
a second motor mounted on the second drive shaft;
a battery configured to provide a current to the first motor and the second motor; and
a power generation-only engine connected to the first motor via a clutch,
wherein the first motor comprises:
a first stator comprising a first stator core and a plurality of first coils wound around the first stator core, wherein the first stator core comprises a plurality of first teeth arranged in a circumferential direction, wherein each of the plurality of first coils is wound around each of the plurality of first teeth;
a second stator comprising a second stator core and a plurality of second coils wound around the second stator core, and wherein the second stator core comprises a plurality of second teeth arranged in a circumferential direction, wherein each of the plurality of second coils is wound around two or more of the plurality of second teeth; and
a rotor disposed between the first stator and the second stator and concentric with the first stator and the second stator.

12. The vehicle drive system of claim 11, wherein the first stator is arranged radially outside the rotor, and the second stator is positioned radially inside the rotor.

13. The vehicle drive system of claim 11, wherein the second stator is arranged radially outside the rotor, and the first stator is positioned radially inside the rotor.

14. The vehicle drive system of claim 11, further comprising a disconnector configured to control a connection between the first drive shaft and the first motor, the disconnector being mounted on the first drive shaft.

15. The vehicle drive system of claim 14, wherein the system is configured such that, based on the power generation-only engine operating, the plurality of first coils and the plurality of second coils are not supplied with a current and the clutch is operated in a connection mode to connect the power generation-only engine to the first motor.

16. The vehicle drive system of claim 14, wherein the system is configured such that, based on the power generation-only engine operating, the disconnector is operated in a disconnection mode to disconnect the first drive shaft from the first motor.

17. The vehicle drive system of claim 14, wherein the system is configured such that, based on the power generation-only engine not operating and in response to a required acceleration of the vehicle being smaller than a predetermined acceleration, among the plurality of first coils and the plurality of second coils, current is applied only to the plurality of first coils.

18. The vehicle drive system of claim 17, wherein the system is configured such that, based on the power generation-only engine not operating, the clutch is operated in a disconnection mode to disconnect the power generation-only engine from the first motor, and the disconnector is operated in a connection mode to connect the first drive shaft to the first motor.

19. The vehicle drive system of claim 17, wherein the system is configured such that, based on the power generation-only engine not operating and in response to a required acceleration of the vehicle being greater than or equal to a predetermined acceleration, the current is applied to both the plurality of first coils and the plurality of second coils.

20. The vehicle drive system of claim 11, further comprising a controller configured to determine whether the power generation-only engine is operating and, in response to determining that the power generation-only engine is operating, to determine that the battery requires charging and to inhibit application of current to both the first coil and the second coil of the first motor.
